(19) United States
(12) Patent Application Publication
(10) Pub. No.: US 2013/0297923 A1
(43) Pub. Date: Nov. 7, 2013

(54) METHOD OF STARTING PERFORMED BY COMPUTER AND COMPUTER APPARATUS

(71) Applicant: FUJITSU LIMITED, Kawasaki-shi (JP)

(72) Inventor: Eiichi Matsuzaki, Koto (JP)

(73) Assignee: FUJITSU LIMITED, Kawasaki-shi (JP)

(21) Appl. No.: 13/773,454

(22) Filed: Feb. 21, 2013

(30) Foreign Application Priority Data
May 7, 2012 (JP) 2012-106235

(51) Int. Cl. G06F 9/44

(52) U.S. Cl. CPC G06F 9/44
USPC 713/2

(57) ABSTRACT

A method of starting performed by a computer is provided. The computer judges whether a start-up mode of the computer is a first mode or a second mode in accordance with a previous operating status of the computer when the computer is turned on. The computer performs first initializing one device or a plurality of devices included in the computer when the start-up mode is the first mode, and second initializing the one device or all or some of the plurality of devices in such a way that the second initializing is completed in a shorter amount of time than the time for the first initializing when the start-up mode is the second mode.

### CROSS-REFERENCE TO RELATED APPLICATION

This application is based upon and claims the benefit of priority of the prior Japanese Patent Application No. 2012-106235, filed on May 7, 2012, the entire contents of which are incorporated herein by reference.

### FIELD

The embodiments discussed herein are related to a method of starting performed by a computer and a computer apparatus.

### BACKGROUND

When a computer is started, initialization such as an inspection and a setup of a device is performed by a basic input/output system (BIOS) to ensure normal operation of the computer. Moreover, the BIOS prepares a procedure for switching to a maintenance program for diagnosis and recovery of a device in anticipation of a malfunction in the computer. Processing performed by the BIOS, the processing including the initialization and the procedure for switching to the maintenance program, is performed in a similar manner at each start-up.

On the other hand, processing that may be omitted in a normal computer and processing that may be performed as posterior handling are also included in the initialization. Furthermore, switching to the maintenance program is not actually performed in most cases when the computer is started.

Moreover, the details of the initialization performed by the BIOS and the processing time differ depending on the type and the number of devices provided in the computer.

Japanese Laid-open Patent Publication No. 04-23036, International Publication Pamphlet No. WO 2009/016708, Japanese Laid-open Patent Publication No. 2006-277472, and Japanese Laid-open Patent Publication No. 2011-164847 are examples of related art.

### SUMMARY

According to an aspect of the invention, a method of starting performed by a computer is provided. The computer judges whether a start-up mode of the computer is a first mode or a second mode in accordance with a previous operating status of the computer when the computer is turned on. The computer performs first initializing one device or a plurality of devices included in the computer when the start-up mode is the first mode, and second initializing the one device or all or some of the plurality of devices in such a way that the second initializing is completed in a shorter amount of time than the time for the first initializing when the start-up mode is the second mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hardware configuration of a computer;

FIG. 2 illustrates a configuration example of a module of a BIOS related to start-up of a computer;

FIG. 3 illustrates an example of a processing method of the BIOS when the computer is started;

FIG. 4 illustrates an example of a normal start-up processing method;

FIG. 5 illustrates an example of a normal initialization processing method;

FIG. 6 illustrates an example of a high-speed start-up processing method;

FIG. 7 illustrates an example of a high-speed initialization processing method;

FIG. 8 illustrates an example of a high-speed initialization processing method;

FIG. 9 illustrates an example of a software configuration related to a change of a start-up mode;

FIG. 10 illustrates an example of a processing method of a start-up mode change program;

FIG. 11 illustrates an example of a software configuration related to a change of a start-up mode in a second embodiment;

FIG. 12 illustrates an example of a screen for setting a start-up mode;

FIG. 13 illustrates an example of a processing method of a start-up mode change program in the second embodiment;

FIG. 14 illustrates a configuration example of a module of a BIOS related to start-up of a computer in the second embodiment;

FIG. 15A illustrates an example of a processing method of the BIOS when the computer is started in the second embodiment;

FIG. 15B illustrates the example of the processing method of the BIOS when the computer is started in the second embodiment;

FIG. 16 illustrates an example of an HDD high-speed start-up processing method;

FIG. 17 illustrates an example of a CD/DVD high-speed start-up processing method;

FIG. 18 illustrates an example of a USB memory high-speed start-up processing method;

FIG. 19 illustrates an example of a network high-speed start-up processing method;

FIG. 20 illustrates an example of a recovery utility high-speed start-up processing method;

FIG. 21 illustrates an example of an HDD high-speed start-up processing method in a third embodiment;

FIG. 22 illustrates an example of a CD/DVD high-speed start-up processing method in the third embodiment;

FIG. 23 illustrates an example of a USB memory high-speed start-up processing method in the third embodiment;

FIG. 24 illustrates an example of a network high-speed start-up processing method in the third embodiment; and

FIG. 25 illustrates an example of a recovery utility high-speed start-up processing method in the third embodiment.

### DESCRIPTION OF EMBODIMENTS

First Embodiment

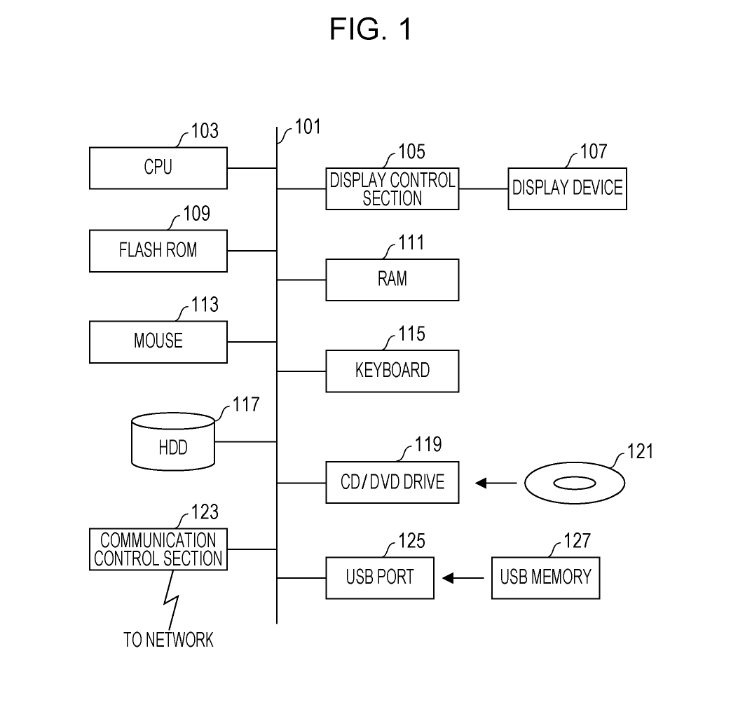

FIG. 1 illustrates an example of a hardware configuration of a computer. A central processing unit (CPU) 103, a display control section 105, a flash read-only memory (ROM) 109, a random access memory (RAM) 111, a mouse 113, a keyboard 115, a hard disk drive (HDD) 117, a compact disc (CD)/digital versatile disc (DVD) drive 119, a communication control section 123, and a universal serial bus (USB) port 125 are connected by a bus 101.

A removable disk 121 may be inserted into the CD/DVD drive 119. Moreover, the USB port 125 may be connected to various kinds of devices (for example, a USB memory 127) having a USB terminal. Furthermore, the communication control section 123 connects to a network.

A program of an operating system (OS) is stored in the HDD 117. The program of the operating system is sometimes stored in, in addition to the HDD 117, the removable disk 121 that is inserted into the CD/DVD drive 119, the USB memory 127 that is connected to the USB port 125, or another system on a network that is connected via the communication control section 123. Moreover, each device also stores a program of a boot strap loader for loading a program of the operating system of the device into the RAM 111. The boot strap loader is sometimes formed of a primary loader and a secondary loader. In such a case, the primary loader loads the secondary loader and the secondary loader loads the operating system.

In this embodiment, start-up of the computer will be described.

When the computer is turned on, the BIOS stored in the flash ROM 109 of a mother board is started. That is, the CPU 103 sequentially reads the code of the BIOS from the flash ROM 109 and executes the code.

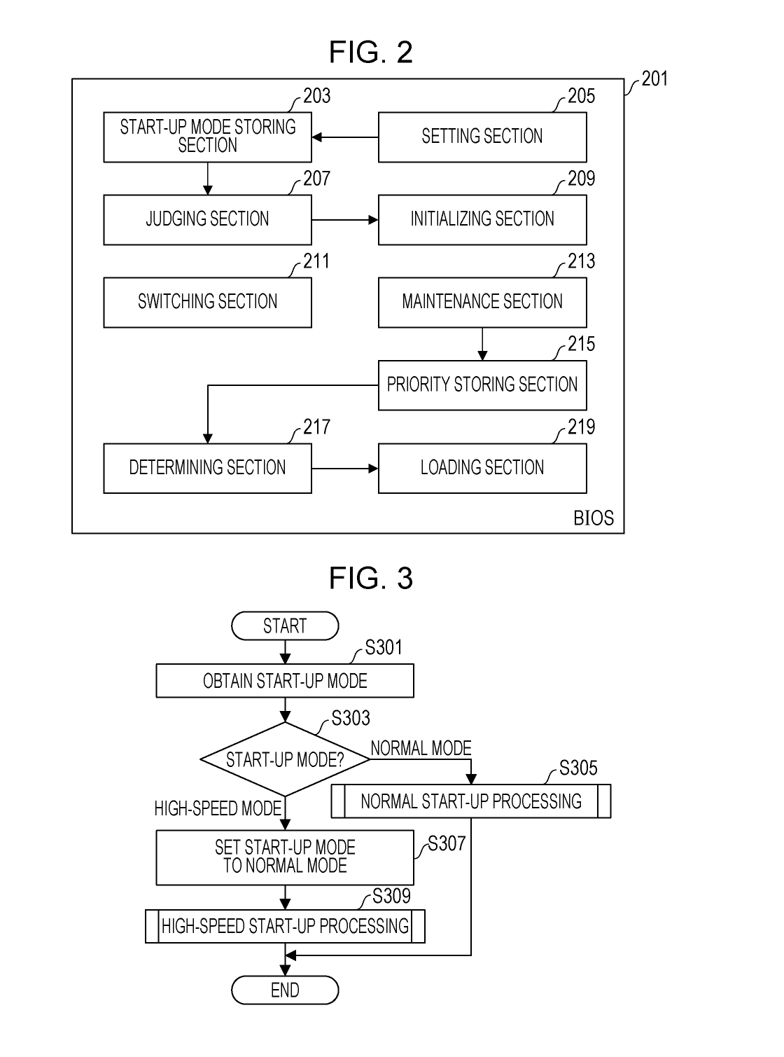

The configuration of the BIOS related to start-up of the computer will be described. In FIG. 2, a configuration example of a module of the BIOS related to start-up of the computer is illustrated. A BIOS 201 has a start-up mode storing section 203, a setting section 205, a judging section 207, an initializing section 209, a switching section 211, a maintenance section 213, a priority storing section 215, a determining section 217, and a loading section 219.

The start-up mode storing section 203 stores a start-up mode. Specifically, the start-up mode storing section 203 is provided in a nonvolatile write area in the flash ROM 109. Therefore, the start-up mode stored in the start-up mode storing section 203 at the end of operation is held until next start-up. As a start-up mode, a normal mode corresponding to normal start-up or a high-speed mode in which start-up is completed in a shorter amount of time than the time for start-up in the normal mode is set.

The setting section 205 sets the start-up mode in the start-up mode storing section 203 to the normal mode in anticipation of an interruption of the operation of the computer.

The judging section 207 obtains the start-up mode stored in the start-up mode storing section 203 and judges whether start-up is performed in the normal mode or the high-speed mode.

The initializing section 209 initializes devices such as the display control section 105, the flash ROM 109, the RAM 111, the mouse 113, the keyboard 115, the HDD 117, the CD/DVD drive 119, the communication control section 123, and the USB port 125 which are included in the computer. Initialization includes operations such as an inspection and a setup of each hardware device and each driver. Moreover, setup operations include processing operation by software such as setting of an initial value and electrical or mechanical operation of the hardware device.

In normal initialization, common inspection and setup for ensuring normal operation of the device are performed. On the other hand, in high-speed initialization, an operation in which normal initialization is simplified by omitting part of the inspection and the setup of each hardware device and each driver or replacing part of the inspection and the setup of each hardware device and each driver with an alternative operation is performed. For example, in the high-speed initialization, the setup is ended when only an interface becomes operable without waiting for an electrical or mechanical setup of the hardware device. Alternatively, the setup may be regarded as being completed during an electrical or mechanical setup of the hardware device.

The high-speed initialization is implemented by, for example, a method by which the initializing section 209 omits part of a command for a hardware device or a driver or a method by which a hardware device or a driver prepares a command from which part of operation is omitted and the initializing section 209 issues the command to the hardware device or the driver.

The switching section 211 accepts a switching instruction for switching to a recovery utility program, the switching instruction given by the user's operation, at the time of start-up in the normal mode.

The maintenance section 213 performs maintenance processing. The maintenance processing includes setup processing, hardware diagnostic processing, recovery utility processing, and the like. The setup processing accepts a condition or the like related to the operation of the BIOS. For example, the setup processing accepts the priority of a device from which an operating system to be started is retrieved. The hardware diagnostic processing conducts a detailed inspection of each device. The recovery utility processing corrects a malfunction. A program of the maintenance processing, such as the recovery utility program, is stored in the HDD 117 and is allowed to be loaded into the RAM 111 when the program is executed.

The priority storing section 215 stores the priority of the above-described device set by the maintenance section 213.

The determining section 217 retrieves a boot strap loader that loads the operating system of a device in accordance with the priority of the above-described device, the priority stored in the priority storing section 215, and determines a device from which the operating system is to be loaded, that is, a boot device.

The loading section 219 loads, from the boot device, a boot strap loader for loading the operating system from the device determined by the determining section 217.

Next, in accordance with an example of FIG. 3, a processing method of the BIOS 201 when a computer is started will be described. The judging section 207 obtains a start-up mode from the start-up mode storing section 203 (S301). The judging section 207 judges whether the start-up mode is a normal mode or a high-speed mode (S303). If the judging section 207 judges that the start-up mode is the normal mode, the BIOS 201 performs normal start-up processing (S305). The normal start-up processing (S305) is start-up processing that assumes handling of a malfunction of the computer caused by an interruption of the operation or a breakdown of a device.

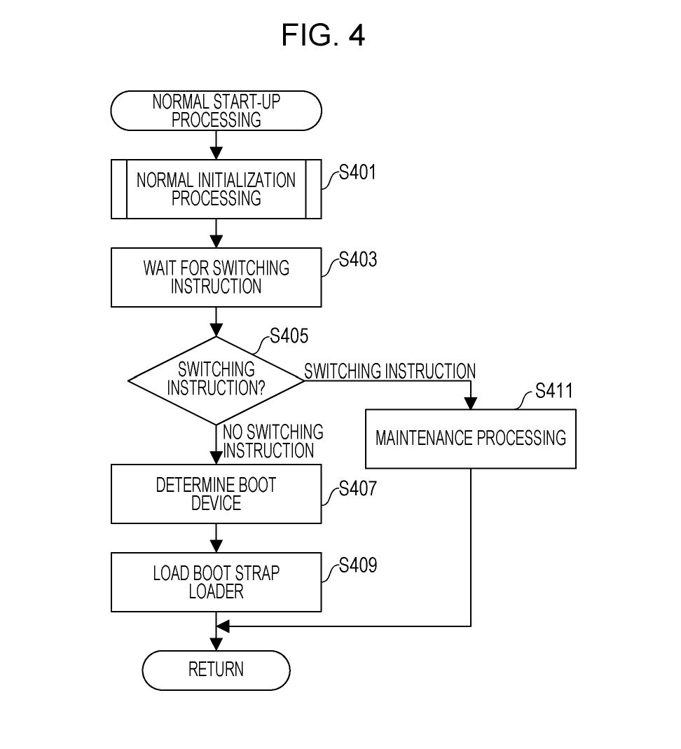

In accordance with an example of FIG. 4, a method of the normal start-up processing (S305) will be described. First, the initializing section 209 performs normal initialization processing (S401).

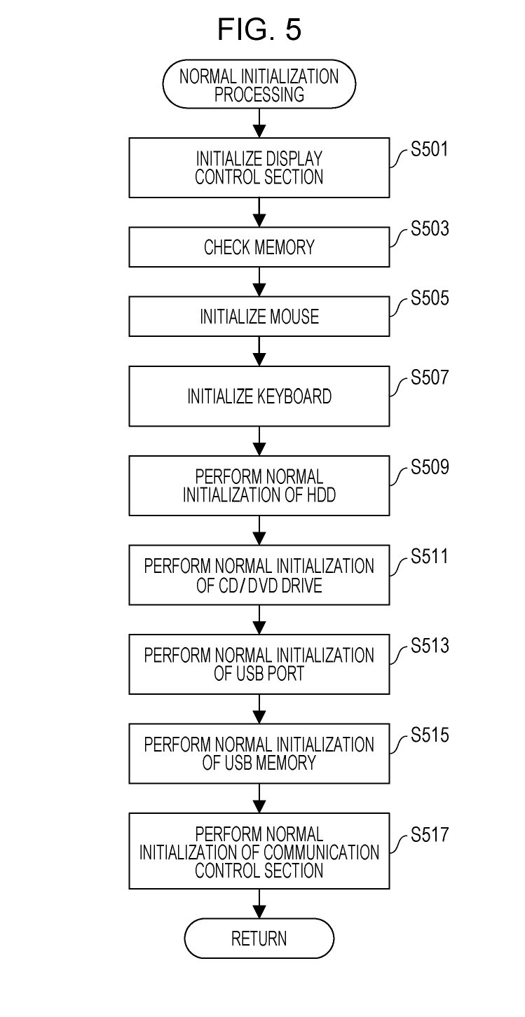

In FIG. 5, an example of a method of the normal initialization processing (S401) is illustrated. The initializing section 209 first initializes the display control section 105 (S501). This makes it possible to perform display by the display device 107. The initializing section 209 then checks the memory (S503). Specifically, the initializing section 209 checks whether or not the flash ROM 109 and the RAM 111 operate normally. Then, the initializing section 209 initializes the mouse 113 (S505) and initializes the keyboard 115 (S507). When the mouse 113 and the keyboard 115 are initialized normally, it becomes possible to accept data from the mouse 113 and the keyboard 115. Next, the initializing section 209 performs normal initialization of the HDD 117 (S509). Likewise, the initializing section 209 also performs normal initialization of the CD/DVD drive 119 (S511). Furthermore, the initializing section 209 also performs normal initialization of the USB port 125 (S513). Then, when the USB memory 127 is connected to the USB port 125, the initializing section 209 performs normal initialization for accessing the USB memory 127 (S515). In addition, the initializing section 209 also performs normal initialization of the communication control section 123 (S517).

Back in FIG. 4, the switching section 211 waits for a switching instruction from the user (S403). The switching instruction is given by operation such as the press of a function key. The switching section 211 waits for a predetermined time and determines the presence or absence of a switching instruction (S405). Specifically, if the switching section 211 accepts a switching instruction in a predetermined time, the switching section 211 determines that there is a switching instruction; if a predetermined time has elapsed before the switching section 211 accepts a switching instruction, the switching section 211 determines that there is no switching instruction.

If it is determined that there is no switching instruction in S405, the determining section 217 determines a boot device (S407). The determining section 217 searches each device for an operating system in accordance with the priority of the device stored in the priority storing section 215. When the determining section 217 finds an operating system in a device with a higher priority, the determining section 217 determines the device as a boot device.

The loading section 219 loads a boot strap loader from the boot device (S409). When the loading section 219 loads the boot strap loader, the BIOS 201 transfers control to the boot strap loader, goes back to FIG. 3, and ends the processing.

The boot strap loader loads a program of the operating system from the boot device and transfers control to the operating system. This completes the start-up of the computer.

On the other hand, if it is determined that there is a switching instruction in S405, the maintenance section 213 performs the above-described maintenance processing (S411). When the maintenance processing (S411) is ended, the BIOS 201 goes back to FIG. 3 and ends the processing.

This is the end of the description of the normal start-up processing (FIG. 3: S305).

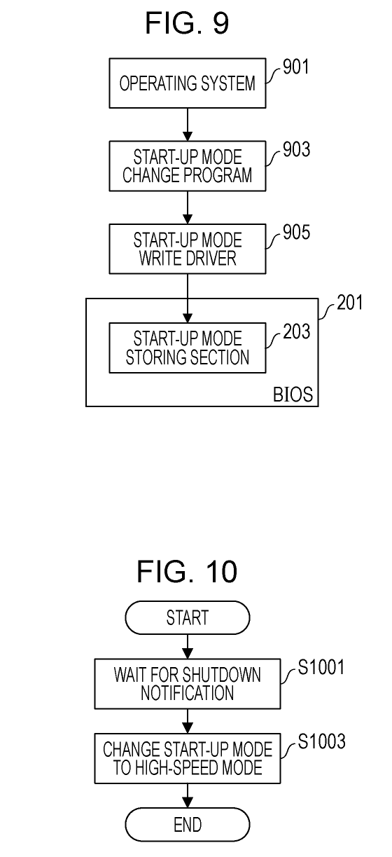

Back in FIG. 3, a case in which it is judged that the start-up mode is the high-speed mode in S303 will be described. When the previous operation is ended normally, the start-up mode becomes the high-speed mode. That is, when the start-up mode is the high-speed mode, it is assumed that an interruption due to a power shutdown or a breakdown has not occurred in the previous operation. An operation to set the start-up mode to the high-speed mode when the previous operation is ended normally will be described by using FIGS. 9 and 10.

If it is judged that the start-up mode is the high-speed mode, the setting section 205 sets the start-up mode to the normal mode (S307). By doing so, when the operation of the computer is interrupted before the operation is ended normally, the next start-up is performed in the normal mode.

Next, the BIOS 201 performs high-speed start-up processing (S309). In the high-speed start-up processing (S309), processing assuming that no malfunction has occurred in the computer is performed.

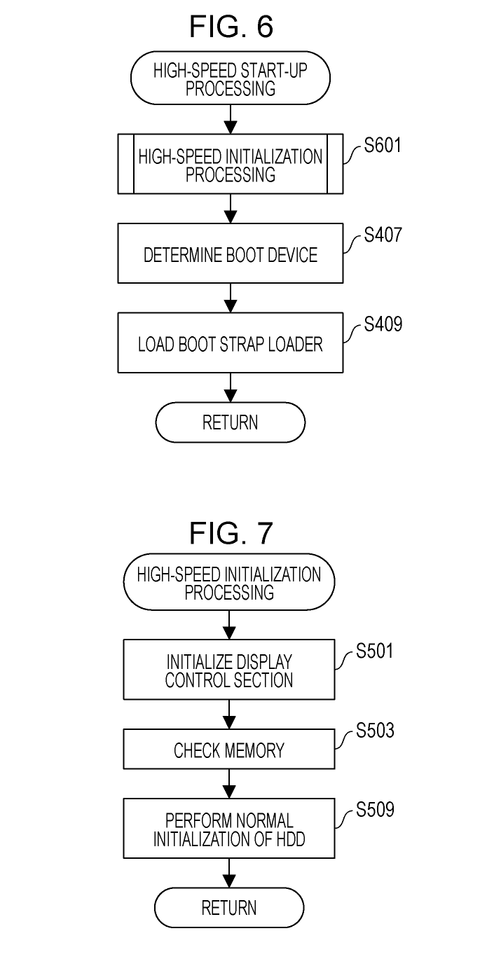

In FIG. 6, an example of a high-speed start-up processing method is illustrated. The initializing section 209 performs high-speed initialization processing (S601). As the high-speed initialization processing (S601), an example in which initialization of some devices is omitted and an example in which initialization of some devices is simplified will be described.

In FIG. 7, an example of a high-speed initialization processing method when initialization of some devices is omitted is illustrated. In this example, initialization of the mouse 113, the keyboard 115, the CD/DVD drive 119, the USB port 125, the USB memory 127, and the communication control section 123 is omitted. The initializing section 209 initializes the display control section 105 (S501), checks the memory (S503), performs normal initialization of the HDD 117 (S509), and ends initialization processing. Initialization of only some of the devices, that is, the mouse 113, the keyboard 115, the CD/DVD drive 119, the USB port 125, the USB memory 127, and the communication control section 123, may be omitted.

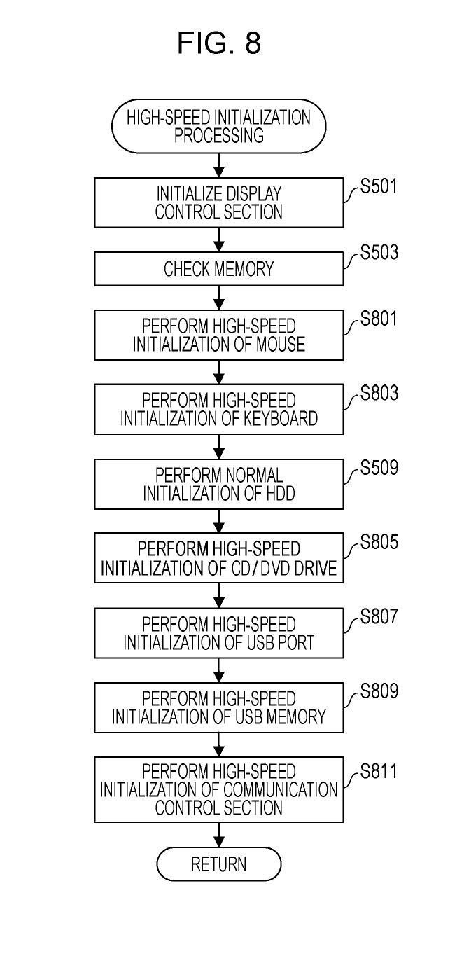

In FIG. 8, an example of a high-speed initialization processing method when initialization of some devices is simplified is illustrated. After the initializing section 209 initializes the display control section 105 (S501) and checks the memory (S503) in the same manner as described above, the initializing section 209 performs high-speed initialization of the mouse 113 (S801) and performs high-speed initialization of the keyboard 115 (S803). The initializing section 209 performs normal initialization of the HDD 117 (S509) to load the operating system from the HDD 117. Then, the initializing section 209 performs high-speed initialization of the CD/DVD drive 119 (S805) and also performs high-speed initialization of the USB port 125 (S807). When the USB memory 127 is connected to the USB port 125, the initializing section 209 performs high-speed initialization of the USB memory 127 (S809) and then performs high-speed initialization of the communication control section 123 (S811).

As described earlier, the high-speed initialization makes it possible to perform processing in a shorter amount of time by omitting part of the processing which is performed in the normal initialization. For example, even in a state in which the initialization of the hardware device is not completed, processing is performed by considering that the initialization is completed when the interface becomes operable. The high-speed initialization may be performed in the following manner: the hardware device or the driver prepares an initialization command in the high-speed mode in which part of initialization operation is omitted and the initializing section 209 issues the initialization command in the high-speed mode. Moreover, the initialization operation may be replaced with an alternative operation.

Back in FIG. 6, the determining section 217 determines a boot device (S407) and the loading section 219 loads a boot strap loader (S409) in the same manner as described earlier. The boot strap loader loads a program of the operating system and transfers control to the operating system. This completes the high-speed start-up.

Next, an operation to set the start-up mode to the high-speed mode when the operation of the computer is ended normally will be described.

In FIG. 9, an example of a software configuration related to a change of a start-up mode is illustrated. A start-up mode change program 903 is stored in the HDD 117, for example. The start-up mode change program 903 is set to be automatically loaded into the RAM 111 and resident in the RAM 111 when an operating system 901 starts processing normally. The start-up mode change program 903 in an executed state receives a shutdown notification from the operating system 901 and changes the start-up mode in the start-up mode storing section 203 of the BIOS 201 to the high-speed mode via a start-up mode write driver 905.

In FIG. 10, an example of a processing method of the start-up mode change program is illustrated. The start-up mode change program 903 waits at all times to receive a shutdown notification from the operating system 901 (S1001). When the start-up mode change program 903 receives a shutdown notification from the operating system 901, the start-up mode change program 903 changes the start-up mode in the start-up mode storing section 203 to the high-speed mode via the start-up mode write driver 905 (S1003).

As described above, by setting the start-up mode to the high-speed mode when the operation is ended normally, start-up is performed at high speed when next operation is started.

Second Embodiment

In the embodiment described above, an example in which start-up is sped up by providing the high-speed mode has been described. In this embodiment, an example in which start-up is further sped up by providing a high-speed start-up mode in which a boot device is specified will be described.

In this embodiment, in addition to a normal mode, an HDD high-speed start-up mode, a CD/DVD high-speed start-up mode, a USB memory high-speed start-up mode, a network high-speed start-up mode, and a recovery utility high-speed start-up mode are provided.

The HDD high-speed start-up mode is a mode in which the HDD 117 is started at high speed as a boot device. The CD/DVD high-speed start-up mode is a mode in which the CD/DVD drive 119 is started at high speed as a boot device. The USB memory high-speed start-up mode is a mode in which the USB memory 127 is started at high speed as a boot device. The network high-speed start-up mode is a mode in which start-up is performed at high speed from an operating system image stored in another system on the network. The recovery utility high-speed start-up mode is a mode in which a program of recovery utility processing, the program stored in the HDD 117, is started at high speed.

In this embodiment, when the operation of the computer is ended, in place of the high-speed mode in the first embodiment, any one of the normal mode, the HDD high-speed start-up mode, the CD/DVD high-speed start-up mode, the USB memory high-speed start-up mode, the network high-speed start-up mode, and the recovery utility high-speed start-up mode, which is specified by the user, is set in the start-up mode storing section 203. As in the first embodiment, when the operation is interrupted, the start-up mode is the normal mode.

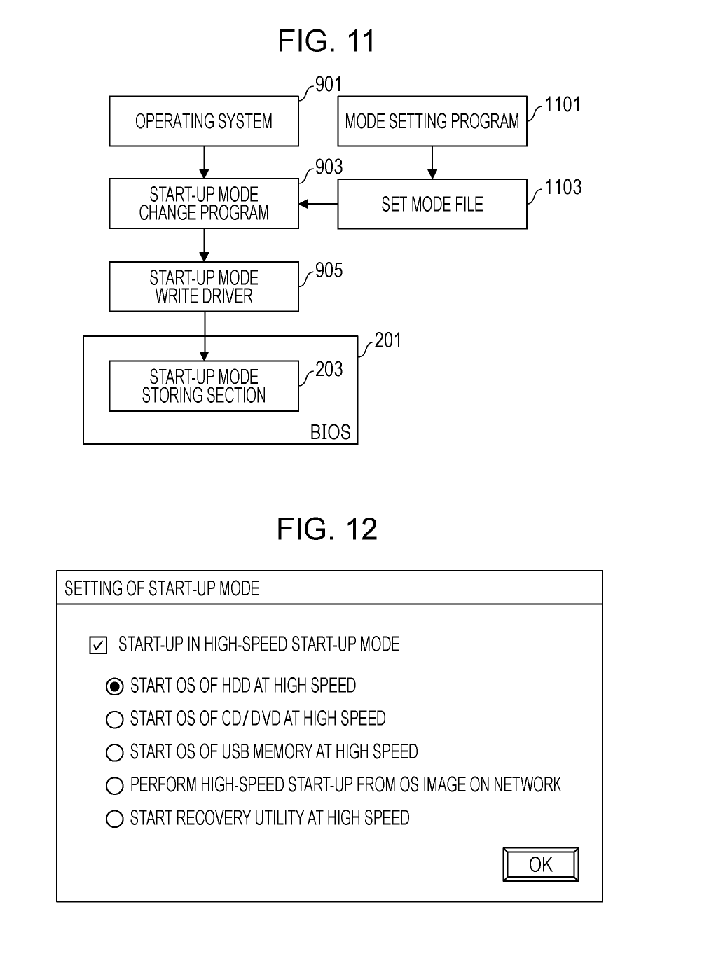

In FIG. 11, an example of a software configuration related to a change of the start-up mode in this embodiment is illustrated. In addition to the operating system 901, the start-up mode change program 903, and the start-up mode write driver 905, the computer has a mode setting program 1101 and a set mode file 1103.

The mode setting program 1101 allows the user to select any one of the normal mode, the HDD high-speed start-up mode, the CD/DVD high-speed start-up mode, the USB memory high-speed start-up mode, the network high-speed start-up mode, and the recovery utility high-speed start-up mode as a start-up mode which is set when the operation is ended normally.

The set mode file 1103 stores the start-up mode selected by the user. The set mode file 1103 is provided in the HDD 117, for example.

The mode setting program 1101 makes the display device 107 display a screen that prompts setting of a start-up mode. In FIG. 12, an example of a screen for setting a start-up mode is illustrated.

When “START-UP IN HIGH-SPEED START-UP MODE” is not checked, this means that the user selects the normal mode.

When “START-UP IN HIGH-SPEED START-UP MODE” is checked, the user is then allowed to check any one of “START OS OF HDD AT HIGH SPEED”, “START OS OF CD/DVD AT HIGH SPEED”, “START OS OF USB MEMORY AT HIGH SPEED”, “PERFORM HIGH-SPEED START-UP FROM OS IMAGE ON NETWORK”, and “START RECOVERY UTILITY AT HIGH SPEED”.

When the user checks “START OS OF HDD AT HIGH SPEED”, this means that the user selects the HDD high-speed start-up mode. When the user checks “START OS OF CD/DVD AT HIGH SPEED”, this means that the user selects the CD/DVD high-speed start-up mode. When the user checks “START OS OF USB MEMORY AT HIGH SPEED”, this means that the user selects the USB memory high-speed start-up mode. When the user checks “PERFORM HIGH-SPEED START-UP FROM OS IMAGE ON NETWORK”, this means that the user selects the network high-speed start-up mode. When the user checks “START RECOVERY UTILITY AT HIGH SPEED”, this means that the user selects the recovery utility high-speed start-up mode. Then, the mode setting program 1101 makes the set mode file 1103 store the selected start-up mode.

The start-up mode change program 903 in this embodiment writes the start-up mode stored in the set mode file 1103 into the start-up mode storing section 203 when the operation of the computer is ended normally.

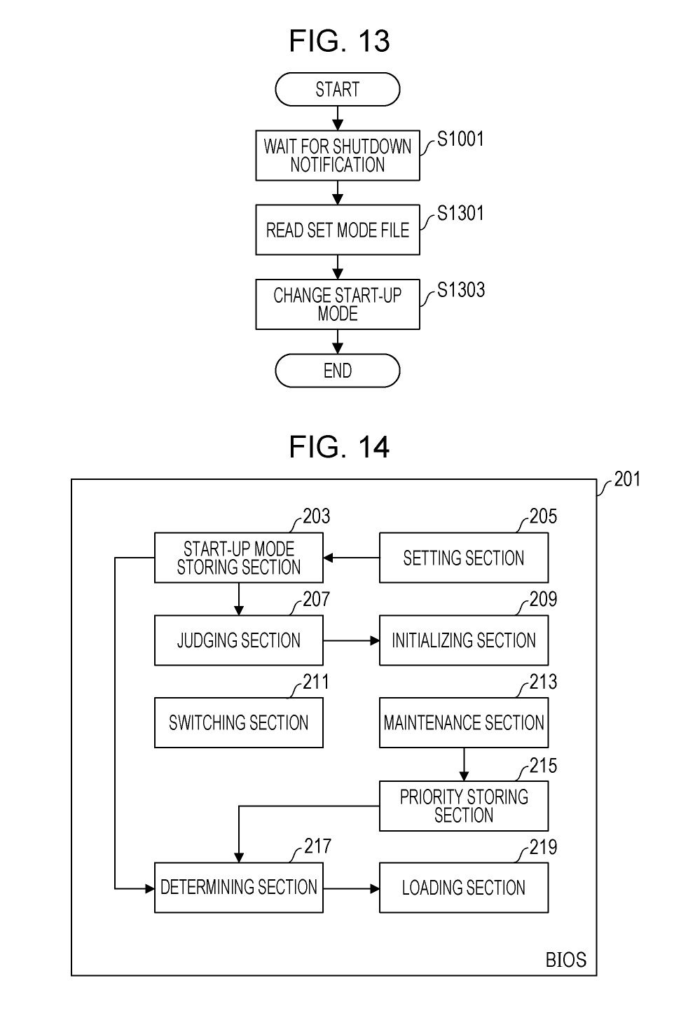

Upon receiving a shutdown notification from the operating system 901, the start-up mode change program 903 rewrites the start-up mode in the start-up mode storing section 203. In FIG. 13, an example of a processing method of the start-up mode change program in the second embodiment is illustrated.

The start-up mode change program 903 waits in the same manner as described earlier to receive a shutdown notification from the operating system 901 (S1001). Upon receiving a shutdown notification from the operating system 901, the start-up mode change program 903 reads the set mode file 1103 and obtains the start-up mode specified by the user (S1301). Then, the start-up mode change program 903 writes the obtained start-up mode into the start-up mode storing section 203 (S1303). In this way, the start-up mode change program 903 changes the start-up mode.

Next, an operation which is performed when the computer is started will be described. In FIG. 14, a configuration example of a module of the BIOS 201 related to start-up of the computer in the second embodiment is illustrated. The module itself is the same as that of the first embodiment. However, the second embodiment differs from the first embodiment in that, in each high-speed start-up mode, the determining section 217 determines a boot device in accordance with the mode stored in the start-up mode storing section 203.

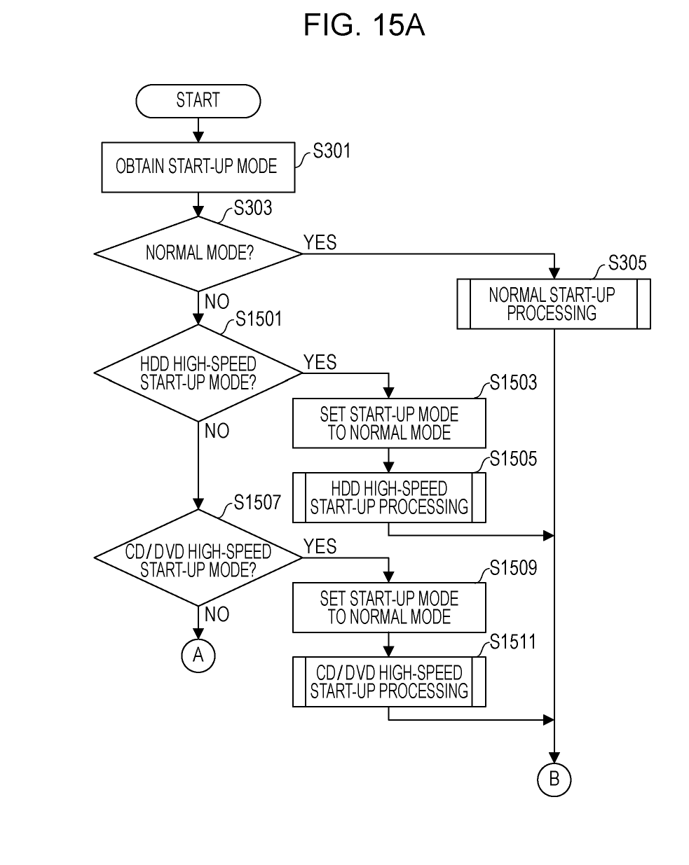

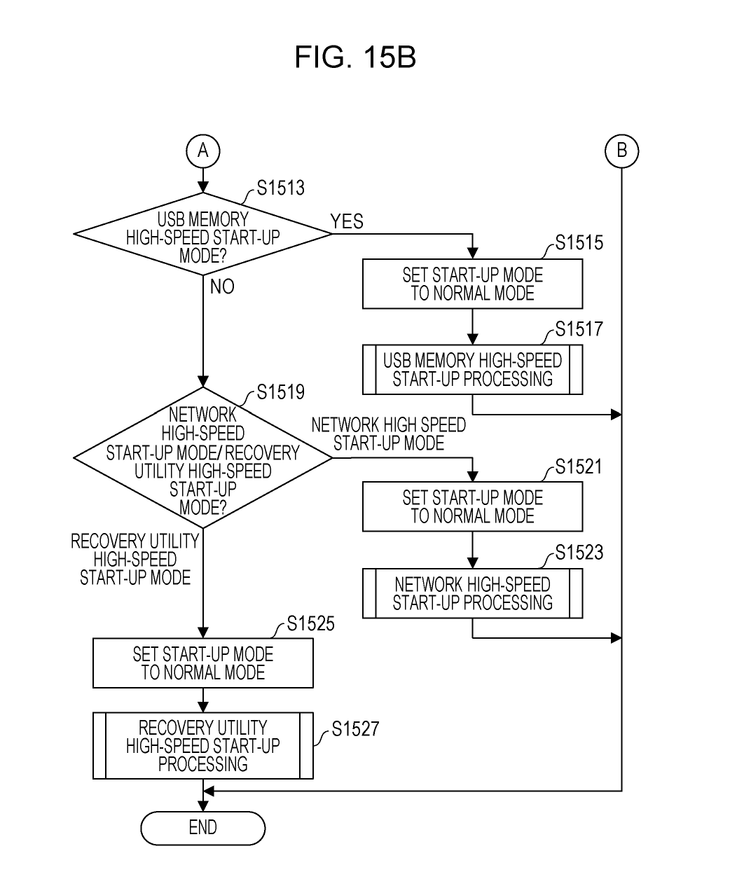

FIG. 15A and FIG. 15B are diagrams illustrating an example of a processing method of the BIOS when the computer is started in the second embodiment. As is the case with the first embodiment, the judging section 207 obtains a start-up mode (S301) and judges whether or not the start-up mode is a normal mode (S303). If the judging section 207 judges that the start-up mode is the normal mode, the BIOS 201 performs normal start-up processing (S305). The normal start-up processing (S305) is the same as that in the first embodiment.

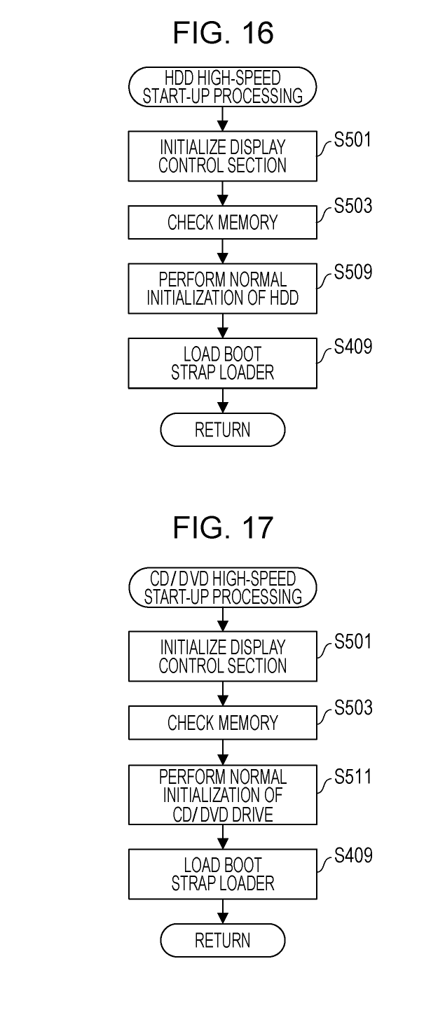

Furthermore, the judging section 207 judges whether or not the start-up mode is an HDD high-speed start-up mode (S1501). If the judging section 207 judges that the start-up mode is the HDD high-speed start-up mode, the setting section 205 sets the start-up mode to the normal mode (S1503), and the BIOS 201 performs HDD high-speed start-up processing (S1505). The reason why the start-up mode is set to the normal mode is the same as that of the first embodiment. The HDD high-speed start-up processing (S1505) will be described later by using FIG. 16.

In addition, if the judging section 207 judges that the start-up mode is not the HDD high-speed start-up mode, the judging section 207 judges whether or not the start-up mode is a CD/DVD high-speed start-up mode (S1507). If the judging section 207 judges that the start-up mode is the CD/DVD high-speed start-up mode, the setting section 205 sets the start-up mode to the normal mode (S1509), and the BIOS 201 performs CD/DVD high-speed start-up processing (S1511). The CD/DVD high-speed start-up processing (S1511) will be described later by using FIG. 17.

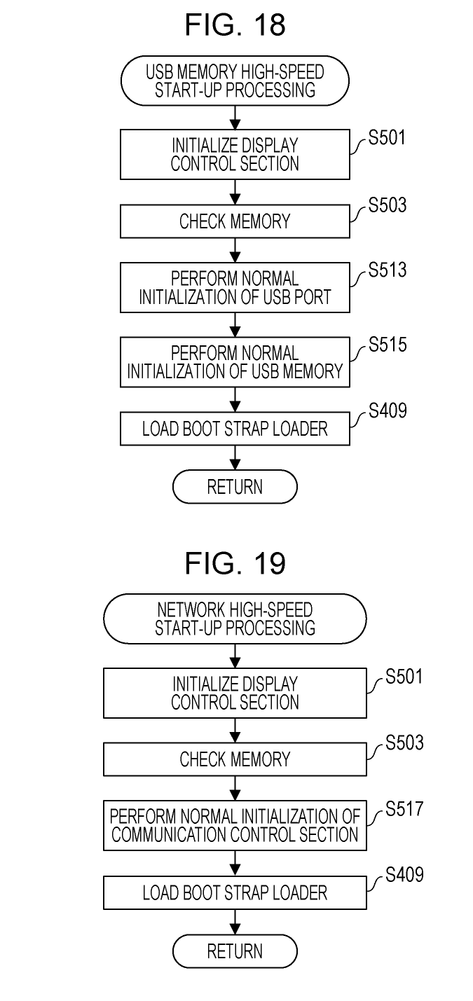

Furthermore, if the judging section 207 judges that the start-up mode is not the CD/DVD high-speed start-up mode, the judging section 207 judges whether or not the start-up mode is a USB memory high-speed start-up mode (S1513). If the judging section 207 judges that the start-up mode is the USB memory high-speed start-up mode, the setting section 205 sets the start-up mode to the normal mode (S1515), and the BIOS 201 performs USB memory high-speed start-up processing (S1517). The USB memory high-speed start-up processing (S1517) will be described later by using FIG. 18.

In addition, if the judging section 207 judges that the start-up mode is not the USB memory high-speed start-up mode, the judging section 207 judges whether the start-up mode is a network high-speed start-up mode or a recovery utility high-speed start-up mode (S1519). If the judging section 207 judges that the start-up mode is the network high-speed start-up mode, the setting section 205 sets the start-up mode to the normal mode (S1521), and the BIOS 201 performs network high-speed start-up processing (S1523). The network high-speed start-up processing (S1523) will be described later by using FIG. 19.

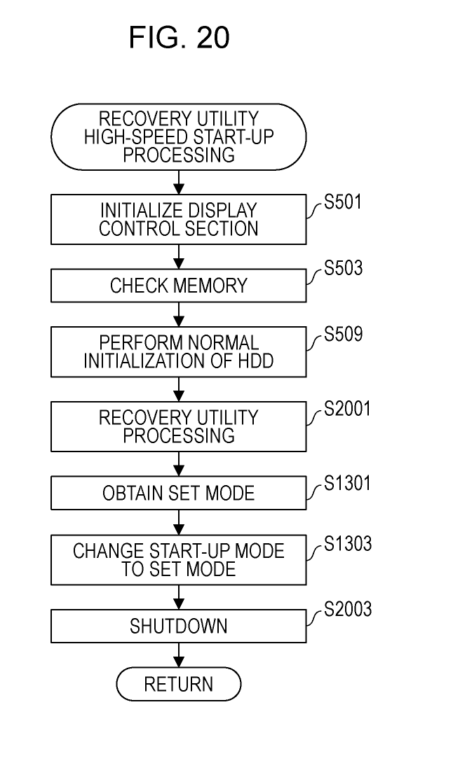

If the judging section 207 judges that the start-up mode is the recovery utility high-speed start-up mode, the setting section 205 sets the start-up mode to the normal mode (S1525), and the BIOS 201 performs recovery utility high-speed start-up processing (S1527). The recovery utility high-speed start-up processing (S1527) will be described later by using FIG. 20.

The HDD high-speed start-up processing (S1505) will be described in detail. In FIG. 16, an example of an HDD high-speed start-up processing method is illustrated. In this example, initialization of the mouse 113, the keyboard 115, the CD/DVD drive 119, the USB port 125, the USB memory 127, and the communication control section 123 is omitted because, when the only requirement is to start the operating system of the HDD 117 normally, initialization of these devices may be performed later. Initialization of only some of the devices, that is, the mouse 113, the keyboard 115, the CD/DVD drive 119, the USB port 125, the USB memory 127, and the communication control section 123, may be omitted.

The initializing section 209 initializes the display control section 105 (S501), checks the memory (S503), and performs normal initialization of the HDD 117 (S509). Then, the loading section 219 loads a boot strap loader from the HDD 117 (S409) and transfers control to the boot strap loader. The boot strap loader loads a program of the operating system from the HDD 117.

The CD/DVD high-speed start-up processing (S1511) will be described in detail. In FIG. 17, an example of a CD/DVD high-speed start-up processing method is illustrated. In this example, initialization of the mouse 113, the keyboard 115, the HDD 117, the USB port 125, the USB memory 127, and the communication control section 123 is omitted because, when the only requirement is to start the operating system of the removable disk 121 inserted in the CD/DVD drive 119 normally, initialization of these devices may be performed later. Initialization of only some of the devices, that is, the mouse 113, the keyboard 115, the HDD 117, the USB port 125, the USB memory 127, and the communication control section 123, may be omitted.

The initializing section 209 initializes the display control section 105 (S501), checks the memory (S503), and performs normal initialization of the CD/DVD drive 119 (S511). Then, the loading section 219 loads a boot strap loader from the removable disk 121 inserted in the CD/DVD drive 119 (S409) and transfers control to the boot strap loader. The boot strap loader loads a program of the operating system from the removable disk 121 inserted in the CD/DVD drive 119.

The USB memory high-speed start-up processing (S1517) will be described in detail. In FIG. 18, an example of a USB memory high-speed start-up processing method is illustrated. In this example, initialization of the mouse 113, the keyboard 115, the HDD 117, the CD/DVD drive 119, and the communication control section 123 is omitted because, when the only requirement is to start the operating system of the USB memory 127 connected to the USB port 125 normally, initialization of these devices may be performed later. Initialization of only some of the devices, that is, the mouse 113, the keyboard 115, the HDD 117, the CD/DVD drive 119, and the communication control section 123, may be omitted.

The initializing section 209 initializes the display control section 105 (S501), checks the memory (S503), performs normal initialization of the USB port 125 (S513), and performs, when the USB memory 127 is connected to the USB port 125, normal initialization for accessing the USB memory 127 (S515). The loading section 219 loads a boot strap loader from the USB memory 127 connected to the USB port 125 (S409) and transfers control to the boot strap loader. The boot strap loader loads a program of the operating system from the USB memory 127 connected to the USB port 125.

The network high-speed start-up processing (S1523) will be described in detail. In FIG. 19, an example of a network high-speed start-up processing method is illustrated. In this example, initialization of the mouse 113, the keyboard 115, the HDD 117, the CD/DVD drive 119, the USB port 125, the USB memory 127, and the communication control section 123 is omitted because, the only requirement is to perform normal start-up from an operating system image of another system on the network, initialization of these devices may be performed later. Initialization of only some of the devices, that is, the mouse 113, the keyboard 115, the HDD 117, the CD/DVD drive 119, the USB port 125, the USB memory 127, and the communication control section 123, may be omitted.

The initializing section 209 initializes the display control section 105 (S501), checks the memory (S503), and performs normal initialization of the communication control section 123 (S517). Then, the loading section 219 loads a boot strap loader from another system on the network (S409) and transfers control to the boot strap loader. The boot strap loader loads a program of the operating system from the operating system image.

The recovery utility high-speed start-up processing (S1527) will be described in detail. In FIG. 20, an example of a recovery utility high-speed start-up processing method is illustrated. In this example, initialization of the mouse 113, the keyboard 115, the CD/DVD drive 119, the USB port 125, the USB memory 127, and the communication control section 123 is omitted because, when the only requirement is to start a recovery utility program of the HDD 117 normally, initialization of these devices may be performed later. Initialization of only some of the devices, that is, the mouse 113, the keyboard 115, the CD/DVD drive 119, the USB port 125, the USB memory 127, and the communication control section 123, may be omitted.

The initializing section 209 initializes the display control section 105 (S501) and checks the memory (S503), and the initializing section 209 performs normal initialization of the HDD 117 (S509). The maintenance section 213 loads a recovery utility program of the HDD 117. The recovery utility program thus loaded performs recovery utility processing (S2001). When the recovery utility processing is ended, the setting section 205 obtains the start-up mode from the set mode file 1103 (S1301) and changes the start-up mode in the start-up mode storing section 203 to the obtained start-up mode (S1303). Then, the BIOS 201 shuts down the computer (S2003).

Third Embodiment

In the second embodiment, the example in which initialization of some devices is omitted has been described. In this embodiment, an example in which initialization of some devices is simplified will be described.

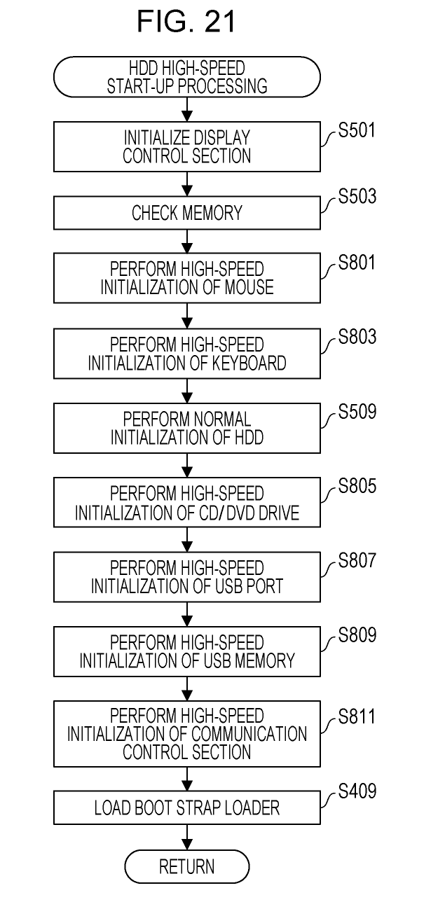

In FIG. 21, an example of an HDD high-speed start-up processing method in this embodiment is illustrated. In this example, initialization of the mouse 113, the keyboard 115, the CD/DVD drive 119, the USB port 125, the USB memory 127, and the communication control section 123 is simplified because, when the only requirement is to start the operating system of the HDD 117 normally, initialization of these devices may be simplified. Initialization of only some of the devices, that is, the mouse 113, the keyboard 115, the CD/DVD drive 119, the USB port 125, the USB memory 127, and the communication control section 123, may be simplified. That is, high-speed initialization of some of the devices may be performed and normal initialization of the remaining devices whose initialization may be simplified may be performed. Alternatively, initialization of the remaining devices whose initialization may be simplified may be omitted.

The initializing section 209 initializes the display control section 105 (S501) and checks the memory (S503). Then, the initializing section 209 performs high-speed initialization of the mouse 113 (S801) and performs high-speed initialization of the keyboard 115 (S803). Furthermore, the initializing section 209 performs normal initialization of the HDD 117 (S509), performs high-speed initialization of the CD/DVD drive 119 (S805), performs high-speed initialization of the USB port 125 (S807), and performs, when the USB memory 127 is connected to the USB port 125, high-speed initialization for accessing the USB memory 127 (S809). In addition, the initializing section 209 also performs high-speed initialization of the communication control section 123 (S811). Then, the loading section 219 loads a boot strap loader from the HDD 117 (S409) and transfers control to the boot strap loader. The boot strap loader loads a program of the operating system from the HDD 117.

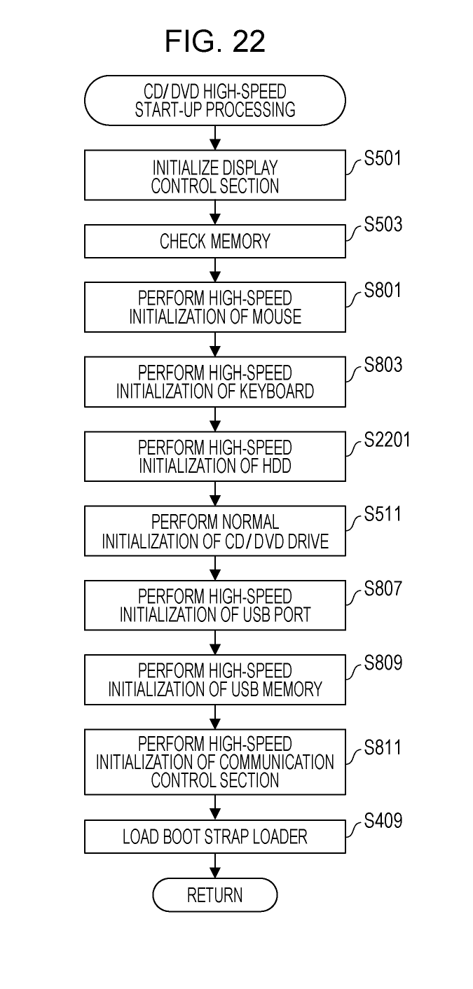

FIG. 22 illustrates an example of a CD/DVD high-speed start-up processing method in this embodiment. In this example, initialization of the mouse 113, the keyboard 115, the HDD 117, the USB port 125, the USB memory 127, and the communication control section 123 is simplified because, when the only requirement is to start the operating system of the CD/DVD drive 119 normally, initialization of these devices may be simplified. Initialization of only some of the devices, that is, the mouse 113, the keyboard 115, the HDD 117, the USB port 125, the USB memory 127, and the communication control section 123, may be simplified. That is, high-speed initialization of some of the devices may be performed and normal initialization of the remaining devices whose initialization may be simplified may be performed. Alternatively, initialization of the remaining devices whose initialization may be simplified may be omitted.

The initializing section 209 initializes the display control section 105 (S501) and checks the memory (S503). Then, the initializing section 209 performs high-speed initialization of the mouse 113 (S801) and performs high-speed initialization of the keyboard 115 (S803). Furthermore, the initializing section 209 performs high-speed initialization of the HDD 117 (S2201), performs normal initialization of the CD/DVD drive 119 (S511), performs high-speed initialization of the USB port 125 (S807), and performs, when the USB memory 127 is connected to the USB port 125, high-speed initialization for accessing the USB memory 127 (S809). In addition, the initializing section 209 also performs high-speed initialization of the communication control section 123 (S811). Then, the loading section 219 loads a boot strap loader from the removable disk 121 inserted in the CD/DVD drive 119 (S409) and transfers control to the boot strap loader. The boot strap loader loads a program of the operating system from the removable disk 121 inserted in the CD/DVD drive 119.

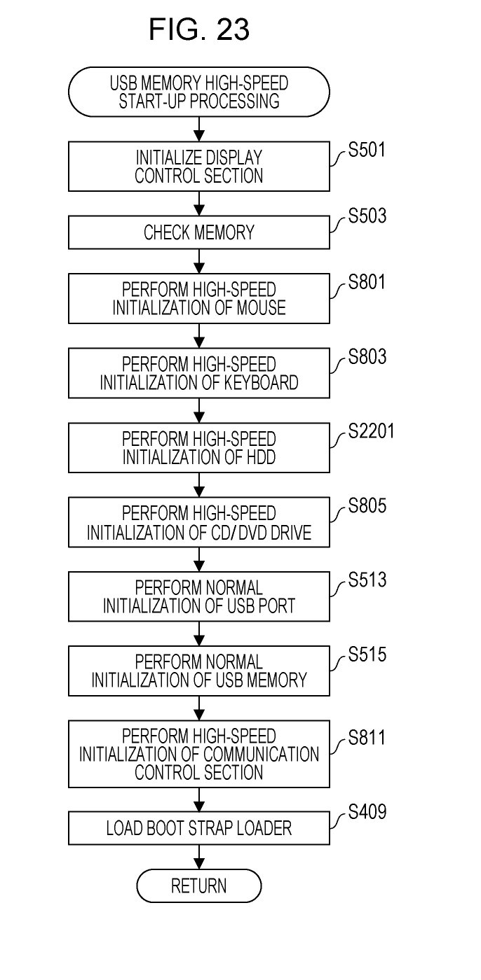

FIG. 23 illustrates an example of a USB memory high-speed start-up processing method in this embodiment. In this example, initialization of the mouse 113, the keyboard 115, the HDD 117, the CD/DVD drive 119, and the communication control section 123 is simplified because, when the only requirement is to start the operating system of the USB memory 127 connected to the USB port 125 normally, initialization of these devices may be simplified. Initialization of only some of the devices, that is, the mouse 113, the keyboard 115, the HDD 117, the CD/DVD drive 119, and the communication control section 123, may be simplified. That is, high-speed initialization of some of the devices may be performed and normal initialization of the remaining devices whose initialization may be simplified may be performed. Alternatively, initialization of the remaining devices whose initialization may be simplified may be omitted.

The initializing section 209 initializes the display control section 105 (S501) and checks the memory (S503). Then, the initializing section 209 performs high-speed initialization of the mouse 113 (S801) and performs high-speed initialization of the keyboard 115 (S803). Furthermore, the initializing section 209 performs high-speed initialization of the HDD 117 (S2201) and also performs high-speed initialization of the CD/DVD drive 119 (S805). The initializing section 209 performs normal initialization of the USB port 125 (S513) and performs, when the USB memory 127 is connected to the USB port 125, normal initialization for accessing the USB memory 127 (S515). In addition, the initializing section 209 also performs high-speed initialization of the communication control section 123 (S811). Then, the loading section 219 loads a boot strap loader from the USB memory 127 connected to the USB port 125 (S409) and transfers control to the boot strap loader. The boot strap loader loads a program of the operating system from the USB memory 127 connected to the USB port 125.

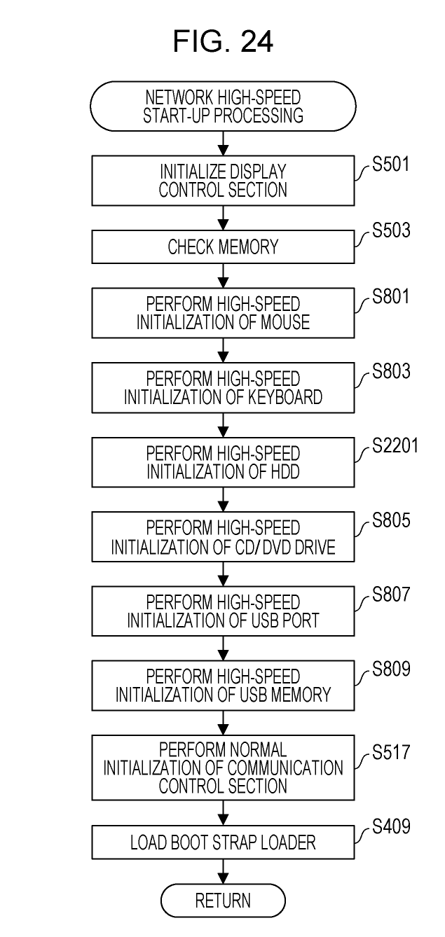

FIG. 24 illustrates an example of a network high-speed start-up processing method in this embodiment. In this example, initialization of the mouse 113, the keyboard 115, the HDD 117, the CD/DVD drive 119, the USB port 125, and the USB memory 127 is simplified because, when the only requirement is to perform normal start-up from an operating system image of another system on the network, initialization of these devices may be simplified. Initialization of only some of the devices, that is, the mouse 113, the keyboard 115, the HDD 117, the CD/DVD drive 119, the USB port 125, and the USB memory 127, may be simplified. That is, high-speed initialization of some of the devices may be performed and normal initialization of the remaining devices whose initialization may be simplified may be performed. Alternatively, initialization of the remaining devices whose initialization may be simplified may be omitted.

The initializing section 209 initializes the display control section 105 (S501) and checks the memory (S503). Then, the initializing section 209 performs high-speed initialization of the mouse 113 (S801) and performs high-speed initialization of the keyboard 115 (S803). Furthermore, the initializing section 209 performs high-speed initialization of the HDD 117 (S2201) and also performs high-speed initialization of the CD/DVD drive 119 (S805). The initializing section 209 performs high-speed initialization of the USB port 125 (S807) and performs, when the USB memory 127 is connected to the USB port 125, high-speed initialization for accessing the USB memory 127 (S809). The initializing section 209 performs normal initialization of the communication control section 123 (S517). Then, the loading section 219 loads a boot strap loader from another system on the network (S409) and transfers control to the boot strap loader. The boot strap loader loads a program of the operating system from the operating system image of the other system on the network.

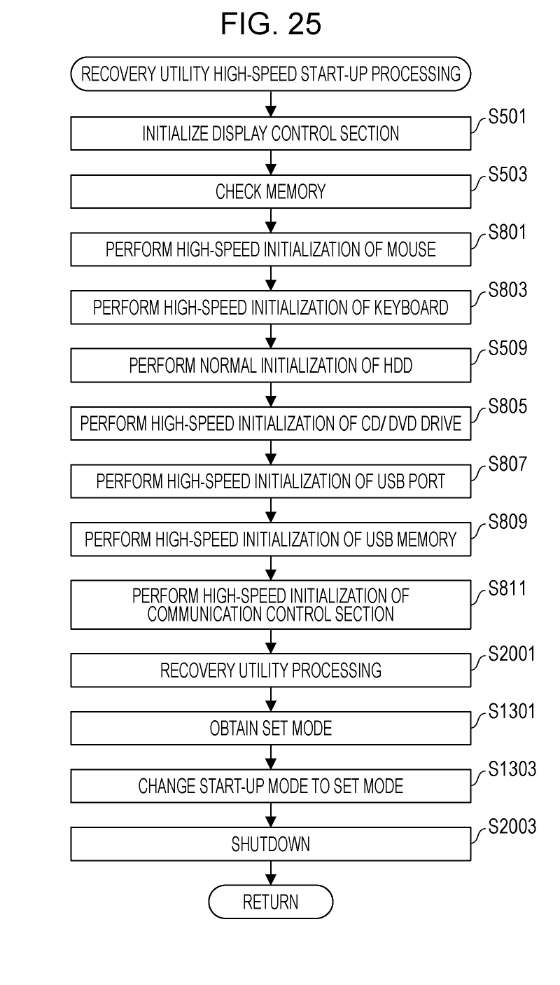

FIG. 25 illustrates an example of a recovery utility high-speed start-up processing method in this embodiment. In this example, initialization of the mouse 113, the keyboard 115, the CD/DVD drive 119, the USB port 125, the USB memory 127, and the communication control section 123 is simplified because, when the only requirement is to start a recovery utility program of the HDD 117 normally, initialization of these devices may be simplified. Initialization of only some of the devices, that is, the mouse 113, the keyboard 115, the CD/DVD drive 119, the USB port 125, the USB memory 127, and the communication control section 123, may be simplified. That is, high-speed initialization of some of the devices may be performed and normal initialization of the remaining devices whose initialization may be simplified may be performed. Alternatively, initialization of the remaining devices whose initialization may be simplified may be omitted.

The initializing section 209 initializes the display control section 105 (S501) and checks the memory (S503). Then, the initializing section 209 performs high-speed initialization of the mouse 113 (S801) and performs high-speed initialization of the keyboard 115 (S803). Furthermore, the initializing section 209 performs normal initialization of the HDD 117 (S509), performs high-speed initialization of the CD/DVD drive 119 (S805), performs high-speed initialization of the USB port 125 (S807), and performs, when the USB memory 127 is connected to the USB port 125, high-speed initialization for accessing the USB memory 127 (S809). In addition, the initializing section 209 also performs high-speed initialization of the communication control section 123 (S811). The maintenance section 213 loads a recovery utility program of the HDD 117. The loaded recovery utility program performs recovery utility processing (S2001). When the recovery utility processing is ended, the setting section 205 obtains the start-up mode from the set mode file 1103 (S1301) and changes the start-up mode in the start-up mode storing section 203 to the start-up mode thus obtained (S1303). Then, the BIOS 201 shuts down the computer (S2003).

Selection of a device whose initialization is to be omitted is not limited to the above-described example. Moreover, selection of a device whose simplified high-speed initialization is to be performed is also not limited to the above-described example. Furthermore, a combination of an omission of initialization and simplified high-speed initialization is also not limited to a particular combination.

Although the embodiments of the present technique have been described, the present technique is not limited to these embodiments. For example, the above-described functional block configuration does not necessarily correspond to an actual program module configuration.

Moreover, the configuration of each storage area described above is a mere example and each storage area does not necessarily have to have the above-described configuration. Furthermore, it is possible to change the order of processing in the processing method if this does not change the processing results. In addition, the processing may be performed in parallel.

A brief account of the embodiments described above is as follows.

The method of starting according to the first embodiment includes judging processing that judges whether the start-up mode of the computer is a first mode or a second mode in accordance with the previous operation status of the computer when the computer is turned on, first initialization processing that initializes one device or a plurality of devices included in the computer when the start-up mode is the first mode, and second initialization processing that initializes the one device or all or some of the plurality of devices in such a way that initialization is completed in a shorter amount of time than the time for the first initialization processing when the start-up mode is the second mode.

As a result, when the computer is turned on, the start-up mode is judged automatically before a mode switching operation is performed and first or second initialization is performed promptly. Moreover, the second mode makes it possible to perform high-speed start-up, and the first mode makes it possible to perform sufficient inspection and setup of the device.

Moreover, in the above-described judging processing, when the previous operation of the computer was ended normally, a judgment is made that the start-up mode is the second mode, and, when the previous operation of the computer was not ended normally, a judgment is made that the start-up mode is the first mode.

This makes it possible to perform high-speed start-up when the previous operation of the computer was ended normally. Since there is little likelihood of a malfunction in the computer when the previous operation was ended normally, it is assumed that an omission of the inspection and the setup of the device does not cause any inconvenience. On the other hand, since there is a likelihood of a malfunction in the computer when the previous operation of the computer was not ended normally, it is preferable to perform sufficient inspection and setup of the device.

Moreover, in the first initialization processing described above, a switching instruction for switching to the maintenance program may be accepted, and, in the second initialization processing, an acceptance of a switching instruction for switching to the maintenance program may be omitted.

This makes it possible to perform start-up at higher speed by omitting the time for waiting for a switching instruction for switching to the maintenance program in the second initialization processing while ensuring a switching procedure for switching to the maintenance program in the first initialization processing. In particular, when the device is broken down, the operation of the computer is often interrupted. Moreover, when the operation of the computer is unexpectedly interrupted due to a power failure or a lightning strike, the device is sometimes broken down due to the influence of voltage fluctuations or the like. In anticipation of a breakdown of the device when the previous operation of the computer is interrupted, providing a procedure for transition to the maintenance program that performs diagnosis and recovery is effective.

Moreover, in the second initialization processing described above, initialization of the one device that is initialized in the first initialization processing or some of the plurality of devices that are initialized in the first initialization processing may be omitted.

This makes it possible to perform start-up at higher speed by omitting initialization processing of some devices. In particular, in the second initialization processing when the previous operation was ended normally, it is possible to omit an inspection and a setup which are less important in the normal computer.

Furthermore, in the second initialization processing described above, initialization of at least one device of all or some of the devices may be completed in a shorter amount of time than the time for initialization of the at least one device in the first initialization processing.

This makes it possible to perform start-up at higher speed by simplifying the initialization processing of at least one device. In particular, in the second initialization processing when the previous operation was ended normally, it is possible to simplify an inspection and a setup which are less important in the normal computer.

A method of starting according to the second embodiment includes judging processing that judges whether the start-up mode of the computer is a first mode that starts a first operating system stored in a first device included in the computer or a second mode that starts a second operating system stored in a second device included in the computer, first initialization processing that initializes the first device when the start-up mode is the first mode, and second initialization processing that initializes the second device and omits initialization of the first device when the start-up mode is the second mode.

This makes it possible to perform start-up at higher speed by omitting initialization of the first device when an operating system is started from the second device in the second mode. That is, it is possible to start the computer more quickly by specifying a boot device based on the start-up mode and omitting initialization of a device other than the boot device.

A method of starting according to the third embodiment includes judging processing that judges whether the start-up mode of the computer is a first mode that starts a first operating system stored in a first device included in the computer or a second mode that starts a second operating system stored in a second device included in the computer, first initialization processing that initializes the first device when the start-up mode is the first mode, and second initialization processing that initializes the second device and initializes the first device in such a way that initialization is completed in a shorter amount of time than the time for initialization of the first device in the first initialization processing when the start-up mode is the second mode.

This makes it possible to perform start-up at higher speed by simplifying initialization of the first device when an operating system is started from the second device in the second mode. That is, it is possible to start the computer more quickly by specifying a boot device based on the start-up mode and simplifying initialization of a device other than the boot device.

Furthermore, loading processing that omits retrieval of a second loader program stored in the second device for loading the second operating system and loads a first loader program stored in the first device for loading the first operating system when the start-up mode is the first mode and omits retrieval of the first loader program and loads the second loader program when the start-up mode is the second mode may be included.

This makes it possible to perform start-up at much higher speed by omitting retrieval operation for a device other than the boot device.

Incidentally, a program for making the computer perform the processing by the methods described above is stored in a computer-readable storage medium or a storage device, such as the flash ROM 109. The start-up mode is stored in a nonvolatile storage area such as the flash ROM 109. It is to be noted that the intermediate processing results may be temporarily stored in a storage device such as the RAM 111.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of starting performed by a computer, the method comprising:
judging whether a start-up mode of the computer is a first mode or a second mode in accordance with a previous operating status of the computer when the computer is turned on;
first initializing one device or a plurality of devices included in the computer when the start-up mode is the first mode; and
second initializing the one device or all or some of the plurality of devices in such a way that the second initializing is completed in a shorter amount of time than the time for the first initializing when the start-up mode is the second mode.

2. The method of starting according to claim 1, wherein
the judging, when the previous operation of the computer was ended normally, judges that the start-up mode is the second mode, and, when the previous operation of the computer was not ended normally, the judging judges that the start-up mode is the first mode.

3. The method of starting according to claim 1, wherein
the first initializing accepts a switching instruction for switching to a maintenance program, and
the second initializing omits an acceptance of a switching instruction for switching to the maintenance program.

4. The method of starting according to claim 1, wherein
the second initializing omits some of the devices in the one device or the plurality of the devices to be initialized in the first initializing.

5. The method of starting according to claim 1, wherein
the second initializing completes initialization of at least one device of all or some of the devices in a shorter amount of time than the time for initialization of the at least one device in the first initializing.

6. The method according to claim 1, further comprising;
judging whether the start-up mode of the computer is a first mode that starts a first operating system stored in a first device included in the computer or a second mode that starts a second operating system stored in a second device included in the computer;
first initializing the first device when the start-up mode is the first mode; and
second initializing initializes the second device and omits initialization of the first device when the start-up mode is the second mode.

7. The method according to claim 6, wherein when the start-up mode is the second mode, the second initializing initializes the second device and initializes the first device in such a way to complete in a shorter amount of time than the time for initialization of the first device in the first initializing.

8. The method according to claim 6, further comprising:
loading processing that omits retrieval of a second loader program stored in the second device for loading the second operating system and loads a first loader program stored in the first device for loading the first operating system when the start-up mode is the first mode, and omits retrieval of the first loader program and loads the second loader program when the start-up mode is the second mode.

9. A computer-readable recording medium having stored therein for causing a computer to execute a start-up process comprising:
judging whether a start-up mode of the computer is a first mode or a second mode in accordance with a previous operating status of the computer when the computer is turned on;
first initializing t one device or a plurality of devices included in the computer when the start-up mode is the first mode; and
second initializing the one device or all or some of the plurality of devices in such a way that initialization is completed in a shorter amount of time than the time for the first initialization processing when the start-up mode is the second mode.

10. The computer-readable recording medium according to claim 9, further comprising:
judging whether the start-up mode of the computer is a first mode that starts a first operating system stored in a first device included in the computer or a second mode that starts a second operating system stored in a second device included in the computer;
first initializing the first device when the start-up mode is the first mode; and
second initializing initializes the second device and omits initialization of the first device when the start-up mode is the second mode.

11. The computer-readable recording medium according to claim 9, wherein when the start-up mode is the second mode, the second initializing initializes the second device and initializes the first device in such a way to complete in a shorter amount of time than the time for initialization of the first device in the first initializing.

12. A computer apparatus comprising:
a judging section that judges whether a start-up mode of the computer is a first mode or a second mode in accordance with a previous operating status of the computer when the computer is turned on; and
an initializing section that performs first initialization processing that initializes one device or a plurality of devices included in the computer when the start-up mode is the first mode, the initializing section that performs second initialization processing that initializes the one device or all or some of the plurality of devices in such a way that initialization is completed in a shorter amount of time than the time for the first initialization processing when the start-up mode is the second mode.

13. The computer apparatus according to claim 11, further comprising:
the judging section that judges whether the start-up mode of the computer is a first mode that starts a first operating system stored in a first device included in the computer or a second mode that starts a second operating system stored in a second device included in the computer; and
the initializing section that performs the first initializing that initializes the first device when the start-up mode is the first mode, the initializing section that performs the second initializing that initializes the second device and omits initialization of the first device when the start-up mode is the second mode.

14. The computer apparatus according to claim 13, wherein when the start-up mode is the second mode, the second initializing initializes the second device and initializes the first device in such a way to complete in a shorter amount of time than the time for initialization of the first device in the first initializing.
